(19) United States
(12) Patent Application Publication
(10) Pub. No.: US 2017/0222426 A1
(43) Pub. Date: Aug. 3, 2017

(54) SURGE PROTECTION DEVICE WITH AN INDEPENDENT CHAMBER COMPRISING A FUSE FOR OVERCURRENT PROTECTION

(71) Applicant: Prosurge Electronics Co., Ltd., Foshan City (CN)

(72) Inventor: Xiaomao MAO, Foshan (CN)

(21) Appl. No.: 15/081,692

(22) Filed: Mar. 25, 2016

(30) Foreign Application Priority Data
Jan. 28, 2016 (CN) 201610056635.2

(51) Int. Cl. H02H 3/08; H02H 3/20; H01H 85/08; H01H 85/38; H01H 85/06

(52) U.S. Cl. CPC H02H 3/085; H01H 85/38; H01H 85/06; H01H 85/08; H02H 3/20; H01H 2085/388

(57) ABSTRACT

A surge protective device with an independent chamber comprising a fuse for overcurrent protection is disclosed. It comprises a first chamber for receiving a voltage sensitive element with a thermal protection switch, and a second chamber independent from the first chamber and provided in the external of the first chamber. The second chamber contains a fuse for power frequency overcurrent protection in series connection with the voltage sensitive element. The surge protection device comprises an independent chamber for power frequency overcurrent protection at outside of the thermal protection device, so as to avoid interference with the components around the fuse. In addition, when the MOV is unexpectedly punctured and got short circuit, the device of the present invention still operates to protect the surge protective surge.

### CROSS-REFERENCE TO RELATED APPLICATION

This application claims priority under 35 U.S.C. §119(a) to Chinese Application No. 201610056635.2, filed Jan. 28, 2016, titled “Surge protection device with an independent chamber comprising a fuse for power frequency overcurrent protection”, the entire disclosure of which is hereby incorporated by reference.

### FIELD

The invention disclosed relates to a surge protection device for circuit protection and, in particular, to a surge protection device with an independent chamber comprising a fuse for overcurrent protection.

### BACKGROUND

A surge protection device is an electronic device used for preventing various electronic equipments, instruments, and communication circuits from damage from surge current or over-voltage caused by sudden interference external to electrical circuits.

A surge protection device, comprising one or more metal-oxide varistors (MOVs), is usually connected between phase line and ground line (or neutral line) to release the energy from over-voltage. When subject to over-voltage, i.e., voltage higher than its rating value, MOV degrades, causing increase of leakage current and in most cases overheating, and possibly will be punctured and got short circuit.

The heating of MOV elevates the temperature of the surge protection device containing the MOV. When the temperature reaches the ignition temperature of combustible materials surrounding the MOV, such as epoxy coatings or plastic housing, it may cause fire. Therefore a surge protection device is usually provided with a thermal response switch, which operates to separate a failed MOV from a power supply circuit when the MOV temperature exceeds a critical value, so as to protect the device.

However, if starting voltage is significantly larger than rating value of the MOV, such as when the electric wire is improperly connected or when it is used in an improper application environment, the MOV may be punctured and got short circuit, and then electrical resistance of the MOV tends to be zero. In this situation, temperature of the MOV will not increase even in presence of a large current, such that the thermal response switch will not be triggered, and thus electronic components can not be protected.

Surge protection devices in prior art are typically not provided with fuses. A fuse has to be externally connected to the device when needed, which is time-consuming and inconvenient. It is not practical to connect a fuse externally in some situations such as limited installation space, which will compromise safety.

### SUMMARY

An object of the invention is to provide a surge protection device which is integrated with an independent overcurrent protection member with minimal increase in size.

These and other objects and advantages of the invention are achieved by the solutions described herein after. It is noted that the objects or advantages are not necessarily achieved at the same time, but instead, can be achieved independently from each other.

In order to achieve one or more objects identified above, in one aspect, a surge protection device with an independent chamber comprising a fuse for overcurrent protection is provided, which comprises a first chamber for receiving a voltage sensitive element with a thermal protection switch; and a second chamber independent from the first chamber and provided external to the first chamber, wherein the second chamber has a fuse connected in series with the voltage sensitive element for power frequency overcurrent protection.

In some embodiments, the second chamber is filled with an arc extinguishing material, such that the fuse for power frequency overcurrent protection is completely encompassed by the arc extinguishing material.

In some embodiments, the thermal protection switch is a thermally responsive mechanical switch. Examples of the thermally responsive mechanical switch can be found in Chinese Utility Model ZL 201420665534.1 or ZL 201520400069.3. In these embodiments, the second chamber is appropriately disposed. In one embodiment, the second chamber is provided at the front end of the first chamber. In another embodiment, the second chamber is provided at any side of the first chamber. In another embodiment, the second chamber is provided at the top or the bottom of the first chamber.

In some embodiments, the thermal protection switch is a thermal cutoff or thermal fuse. In this situation, the first chamber is located entirely inside the second chamber.

In some embodiments, the arc extinguishing material is selected from insulating material particles and thermoplastic or thermosetting plastics or rubbers. In some embodiments, the insulating material particle is selected from sand particle, glass particle, plastic particle and rubber particle. In some embodiments, the arc extinguishing material is selected from quartz sand particle, silica gel and resin, such as epoxy resin or phenolic resin. Solid particles of other forms are also possible, such as solid fine particles having an appropriate particle size and fluidity.

In some embodiments, the fuse for power frequency overcurrent protection is simply a wire-shaped or plate-shaped fuse made of silver, copper, or metal alloy, such as alloy comprising Sn and Bi, or the fuse for power frequency overcurrent protection is wire-shaped or plate-shaped fuse housed in an enclosure, for example a glass tube fuse, a ceramic tube fuse, or a plastic shell fuse.

In one embodiment of the present invention, the fuse for power frequency overcurrent protection is formed by one of the terminals or contacting pins of the surge protection device. For example, the fuse for power frequency overcurrent protection is formed by reducing the sectional area, such as by reducing thickness and/or width, of at least one part of the terminal or contacting pin.

In some embodiments, the voltage sensitive element is a metal-oxide varistor (MOV).

The surge protection device according to the present invention comprises an independent chamber external to the thermal protection device for power frequency overcurrent protection, so as to avoid interference with components surrounding the fuse. For example, when an enclosure of a fuse is broken or exploded due to insufficient breaking ability, the independent chamber can protect the components (such as the MOV) around the device from being damaged by the explosion.

In addition, compared to the solution where an external fuse is connected in series with the surge protection device, in the present invention, it is not necessary to connect an external fuse. Moreover, its small size allows for installing in a narrow space where it is not practical to connect an external fuse. Further, since the fuse is located inside the independent chamber having arc extinguishing materials, no electric arc will be generated even when the fuse for power frequency overcurrent protection is melted, so as to improve safety of the device.

In addition, the MOV degrades due to long time use, which leads to decrease of its overvoltage withstanding capacity. In some situations where the starting voltage is too large due to improper connection of electric wire or improper application environment, the MOV will be directly punctured and got short circuit, and the thermal responsive switch can't work to cut off power frequency current leading to surge protective device catch on fire. However, the fuse for power frequency overcurrent protection inside an independent chamber can still operate to cut off power frequency current and prevent surge protective device from fire, thereby improving safety of the device.

### BRIEF DESCRIPTION OF THE DRAWINGS

The invention will be described in various embodiments in reference to the accompanied drawings, in which the features shown are illustrative only and should not be interpreted as limiting to the scope of the present invention.

FIG. 1 is an inner structural view of a typical surge protection device in its normal working state.

FIG. 2 is an inner structural view of the surge protection device of FIG. 1 when its thermal protection switch is failed.

FIG. 3 shows a surge protection device according to one embodiment of the present invention having a fuse chamber.

FIG. 4 shows a schematic view of the circuit of a surge protection device according to one embodiment of the present invention.

FIG. 5 shows a surge protection device according to another embodiment of the present invention having a fuse chamber.

FIG. 6 shows an arrangement of the first chamber and second chamber according to one embodiment of the present invention.

FIG. 7 shows an arrangement of the first chamber and second chamber according to another embodiment of the present invention.

FIG. 8 shows a surge protection device according to the third embodiment of the present invention having a fuse chamber.

FIG. 9 shows a schematic view of the circuit of the surge protection device according to the third embodiment of the present invention.

### DETAILED DESCRIPTION

The present invention will be described in conjugation with embodiments and drawings. It is understood that those embodiments are provided as examples, and one or more features from one of the embodiments may be combined with one or more features from another embodiment, to form a new embodiment comprising combinations of features from different embodiments. All of the embodiments are contemplated and within the scope of the present invention. Similarly, one feature of the invention as shown in one figure may be combined with another feature of the invention shown in another figure to constitute an embodiment comprising both of the features, which is also within the scope of the present invention.

### Example 1

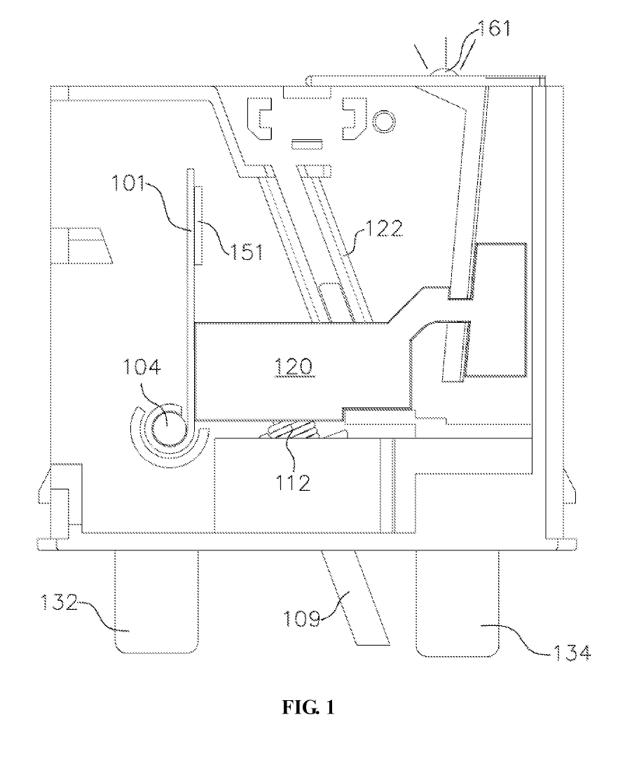

FIG. 1 shows a typical surge protection device whose insulating housing is omitted to show inside details. The surge protection device is generally in a square shape, and has two terminals or connecting pins 132, 134 respectively for connection with the electrical power line and the ground or neutral line. FIG. 1 shows mainly an exemplary thermal response switch of the surge protection device, which comprises a sliding block 120, a guiding track 122, a guiding rod 109 and a spring 112 covering the guiding rod 109. In effective state, terminal 151 of the voltage sensitive element (such as MOV) is connected with a rotatable bar 101 through low-temperature soldering material. The rotatable bar 101 can rotate around pivot 104 and is electrically connected with terminal 134.

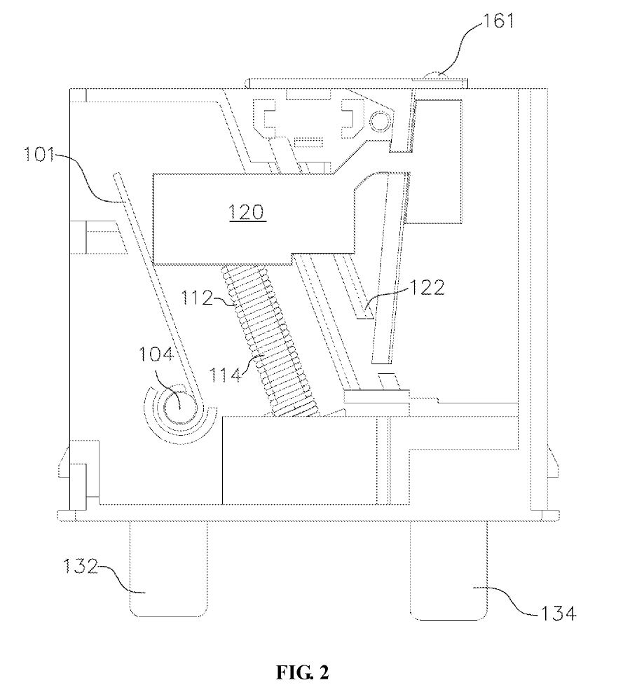

In effective state, the thermal response switch is maintained by the rotatable bar 101 through the sliding block 120. When the MOV is heated due to overvoltage, the low-temperature soldering material will be softened or melted, such that the rotatable bar 101 will separate from the terminal 151, releasing its binding to the sliding block 120 of the thermal response switch. The sliding block 120 will slide obliquely upward due to the action of spring 112, thereby further expending the space between the rotatable bar 101 and the terminal 151, reducing possibility of generating an electric art and eliminating the electric art when it is generated. FIG. 2 shows the structural view of the surge protection device after its thermal response switch is released.

Other structures of the thermal response switch can also be possible and available in the art, such as those described in U.S. Pat. No. 6,430,019 and Chinese patent ZL 201420665534.1. The thermal response switch can also be provided with a failure indicator 161 to indicate whether the thermal response switch is triggered. For example, it can be the thermal response switch described in U.S. Pat. No. 6,430,019.

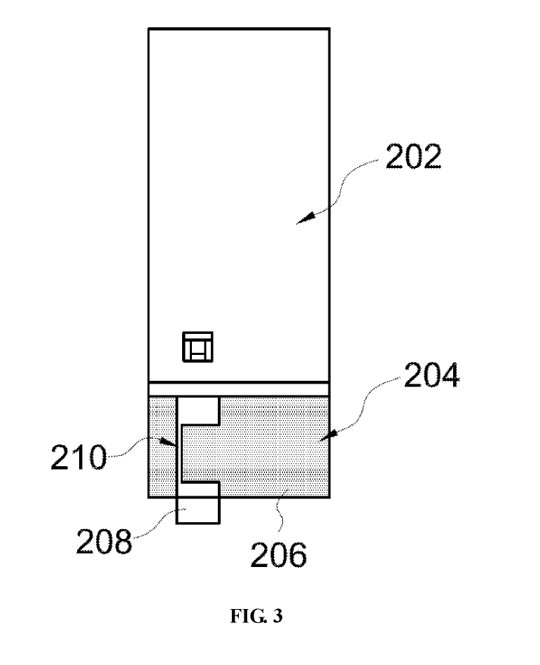

FIG. 3 shows a side view of an exemplary surge protection device according to the present invention, which comprises a first chamber 202 for receiving a voltage sensitive element and a thermal protection switch (a thermally responsive mechanical switch or a temperature fuse, not shown). The voltage sensitive element and the thermal protection switch can have structures similar to those shown in FIGS. 1 and 2.

The surge protection device further comprises a second chamber 204, which is an independent chamber for power frequency overcurrent protection provided external to the first chamber 202. In this embodiment, the second chamber is provided at the front end of the first chamber 202, i.e., at an end extended from terminal or connecting pin 208. Only one terminal is shown in the figure. The second chamber 204 has a horizontal width substantially the same as that of the first chamber, such that they have aligned surfaces and externally viewed as a single piece.

Terminal 208 longitudinally extends through the second chamber 204 and out of the other side. Terminal 208 has a significantly decreased width in its middle part 210, making the width of the part 210 comparable to diameter of a wire fuse for power frequency overcurrent protection. On the other hand, the terminal 208 is generally made of copper; therefore the middle part 210 corresponds to a very fine copper wire. In the present invention, the second chamber 204 is filled with an arc extinguishing material, such as quartz sand particle. The arc extinguishing material surrounds the middle part 210 of the terminal 208. Therefore when the middle part 210 is melted due to overvoltage, the quartz sand particle, which has an appropriate particle size and thereby an appropriate fluidity, can instantly fill in the space formed by the melting, so as to cut off any possible electric arc.

The particle size of the quartz sand particle or other insulating solid materials used in the present invention can be determined by a skilled person in the art by conventional experiments. Methods for measuring the particle size are readily available technology in the art. The sectional area of the wire fuse for power frequency overcurrent protection can be determined by conventional experiments. As known by a skilled person in the art, material and sectional area of the wire fuse for power frequency overcurrent protection are key factors for determining its electrical resistance. When current runs through the fuse for power frequency overcurrent protection, the fuse will be heated. The heat increases over time or as current intensity increases. The heat generating speed is determined by the current and resistance, while the heat dissipating speed is determined by the structure of the fuse and its surrounding environment.

The fuse for power frequency overcurrent protection will generally not be melted if the heat generating speed is lower than the heat dissipating speed, and will not be melted for quite a long time if the heat generating speed is the same as the heat dissipating speed. If the heat generating speed is faster than the heat dissipating speed, heat accumulation will occur. When the temperature increases to be higher than the melt point of the fuse for protection, the fuse will be melted, thus cutting off electrical connection between components located upstream and downstream of the fuse. Therefore, a skilled person in the art may choose the material and cross section area of the fuse for power frequency overcurrent protection based on actual situation, such as short circuit rated value from power supply system.

Overcurrent may be caused by various factors. For example, aging of the MOV will occur due to long time use in site, which may cause decrease of MOV TOV(temporary over-voltage) withstanding capacity which possibly leads to MOV punctured and get short circuit under some TOV and surge protective device will catch on fire, in this case fuse will work to cut off power frequency current and protect surge protective device. In some situations where the thermal response switch can not be released due to some special reasons such as too short disconnection distance or can't cut off arc between thermal response switch disconnection, and thus the MOV is punctured and got short circuit, the fuse will work to cut off power frequency current and prevent surge protective device from fire.

In another situation, the MOV will also be punctured and got short circuit in a short moment due to too high over-voltage caused by malfunction of power grid, improper wiring, or improper application environments, and the thermal response switch will not be released. Also in this case, the fuse will work to cut off power frequency current and prevent surge protective device from fire.

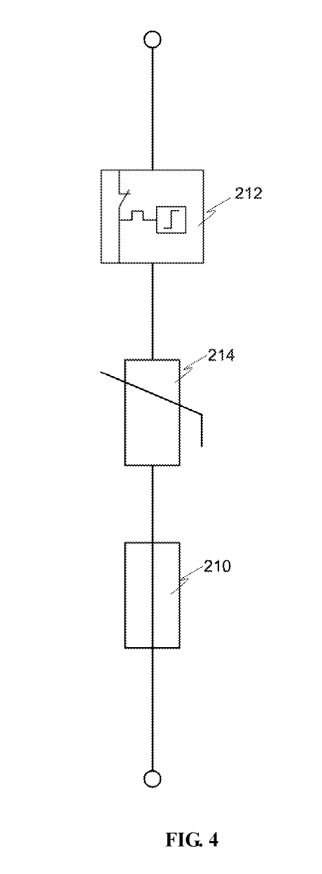

FIG. 4 shows the circuit in this example, wherein 212 represents a mechanical detachable structure, 214 represents a varistor MOV, and 210 represents a fuse for power frequency overcurrent protection in an independent chamber according to the present invention, connected in series.

### Example 2

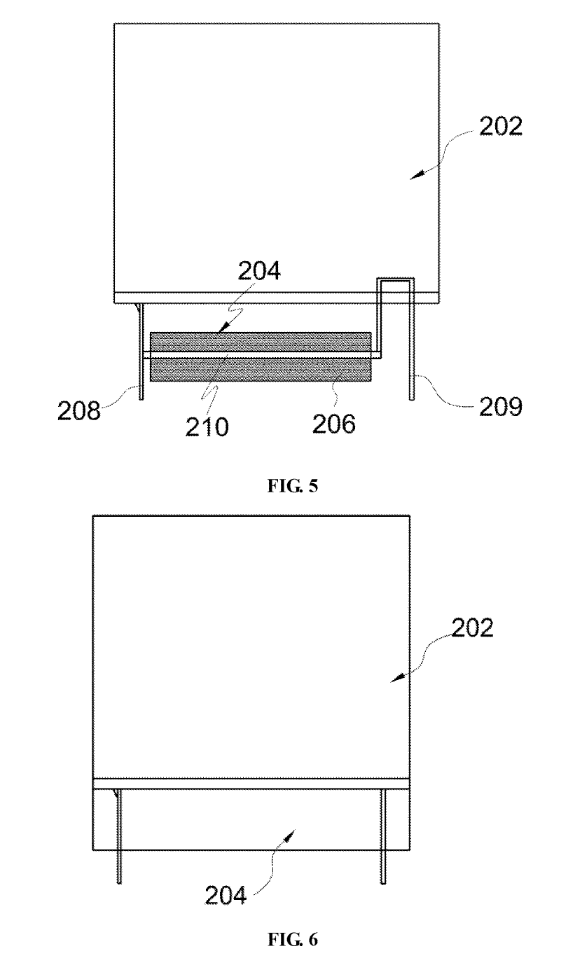

FIG. 5 shows a surge protection device according to another embodiment of the present invention. The surge protection device comprises a first chamber 202 for receiving a voltage sensitive element and a thermal protection switch (not shown), and a second chamber 204 which is provided at the front end of the first chamber in the present embodiment. The surge protection device further comprises a terminal 208, and another terminal which is not shown. In the present embodiment, the terminal 208 is in series connection with the second chamber 204. Inside the second chamber 204, a wire fuse for power frequency overcurrent protection 210 and an arc extinguishing material 206 are provided, with the arc extinguishing material 206 surrounding the wire fuse 210, thereby when the fuse is melted, the arc extinguishing material 206 can instantly fill in the space formed due to the melting, so as to cut off any possible electric arc.

One end of the fuse for power frequency overcurrent protection 210 is connected in series with the terminal 208, and the other end is connected in series with terminal 209. It should be noticed that, the terminal 208 is generally invisible from outside, and the terminal 209 is in the external of the surge protection device instead.

In the present embodiment, the terminals 208 and 209 are located in different horizontal positions with respect to the first chamber 202. In other embodiments, the terminals 208 and 209 may be located in the same horizontal position with respect to the first chamber 202.

In addition, in the present embodiment, the second chamber 204 has a horizontal size different from that of the first chamber 202. However, it can be anticipated by a skilled person in the art that they can have the same horizontal size, such as in the arrangement shown in FIG. 6.

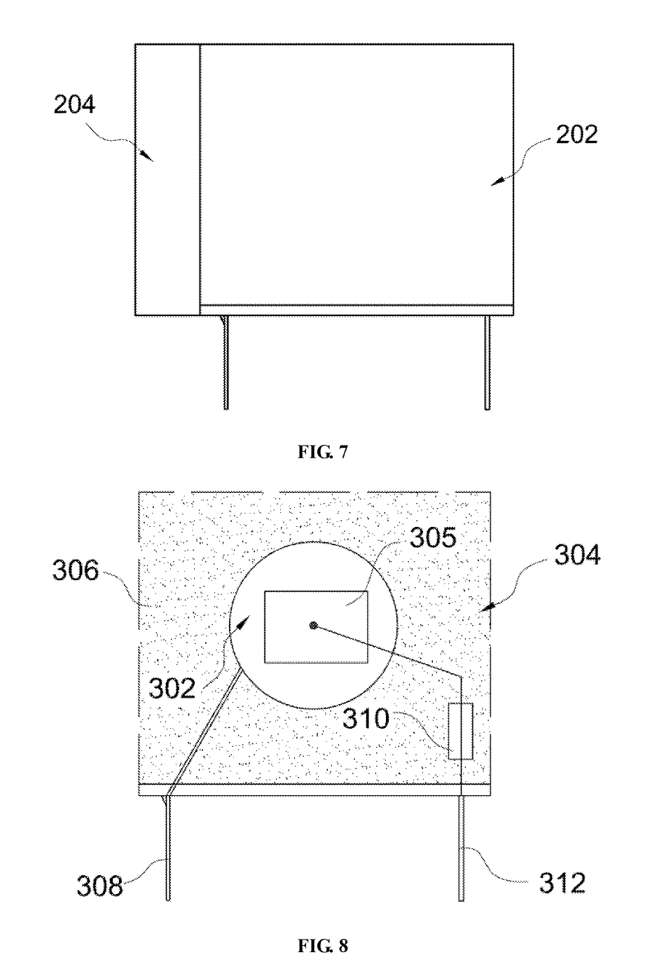

Alternatively, the second chamber 204 can also be provided at any side or at the bottom or top of the first chamber 202, and has a side/bottom/top size same as that of the first chamber 202, making them form a single body, such as a cuboid or cube, when viewed from the external. For example, FIG. 7 shows a structural view in which the second chamber 204 is located at one side of the first chamber 202.

### Example 3

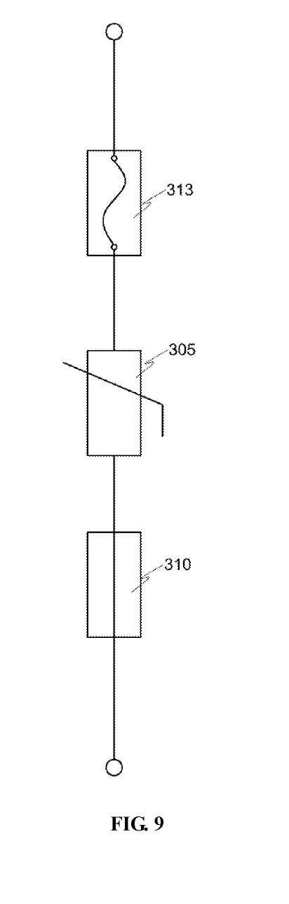

FIG. 8 shows a surge protection device according to another embodiment of the present invention. The surge protection device comprises a first chamber 302 for receiving a voltage sensitive element 305 and a temperature fuse 313 (FIG. 9), and a second chamber 304. The second chamber 304 surrounds the entirety of the first chamber 302, and is filled with arc extinguishing material 306. The surge protection device further comprises terminals 308 and 312, respectively connected with the positive and negative terminals of the voltage sensitive element 305. In the present embodiment, a wire fuse for power frequency overcurrent protection 310 is provided in the second chamber 304, surrounded by the arc extinguishing material 306. One end of the wire fuse 310 is connected in series with the voltage sensitive element 305, and the other end is connected in series with the terminal 312. It differs from Examples 1 and 2 in that, the arc extinguishing material 306 in the present embodiment is formed by injecting a heat resisting hot melt material, such as a hot melt silica gel, into the second chamber 304. Therefore the material encapsulates the wire fuse 310 when it cools down. Thus no electric arc will be generated when the wire fuse is melted, because of the insulating material encapsulating the wire fuse.

FIG. 9 shows the circuit in this example, wherein 313 represents a thermal fuse, 305 represents a varistor MOV, and 310 represents a fuse for power frequency overcurrent protection in an independent chamber according to the present invention, connected in series. It should be understood that various embodiments have been described with reference to the accompanying drawings in which only some example embodiments are shown. As described above, the feature or feature combinations in respective embodiment can independently appear or be used with a feature or feature combinations in other embodiments, as long as one or more objects of the present invention is achieved.

1. A surge protection device with an independent chamber comprising a fuse for overcurrent protection, comprising:
a first chamber for receiving a voltage sensitive element with a thermal protection switch; and
a second chamber independent from the first chamber and provided external to the first chamber, wherein the second chamber has a fuse for power frequency overcurrent protection connected in series with the voltage sensitive element.

2. The surge protection device of claim 1, wherein the second chamber is filled with an arc extinguishing material, such that the fuse for power frequency overcurrent protection is completely surrounded by the arc extinguishing material.

3. The surge protection device of claim 1, wherein the thermal protection switch is a thermally responsive mechanical switch or a thermal fuse.

4. The surge protection device of claim 3, wherein the thermal protection switch is a thermally responsive mechanical switch, and the second chamber is provided at a front end, any side, a top or a bottom of the first chamber.

5. The surge protection device of claim 3, wherein the thermal protection switch is a thermal fuse, and the first chamber is located entirely inside the second chamber.

6. The surge protection device of claim 2, wherein the arc extinguishing material is selected from insulating material particles and thermoplastic or thermosetting plastics or rubbers.

7. The surge protection device of claim 6, wherein the insulating material particle is selected from sand particle, glass particle, plastic particle and rubber particle.

8. The surge protection device of claim 6, wherein the arc extinguishing material is selected from quartz sand particle, silica gel and resin.

9. The surge protection device of claim 1, wherein the fuse for power frequency overcurrent protection is a wire-shaped or plate-shaped silver, copper, or metal alloy, or the fuse for power frequency overcurrent protection is a glass tube fuse, a ceramic tube fuse, or a plastic shell fuse.

10. The surge protection device of claim 4, wherein the fuse for power frequency overcurrent protection is formed by one of terminals of the surge protection device.

11. The surge protection device of claim 10, wherein the fuse for power frequency overcurrent protection is formed by reducing a sectional area of at least one part of the one of the terminals.
